(19) United States
(12) Patent Application Publication
(10) Pub. No.: US 2008/0009214 A1
(43) Pub. Date: Jan. 10, 2008

(54) Flame-retardant sun protection, glare protection and blackout articles

(76) Inventor: Johann Aigner, Klam (AT)

Correspondence Address: WENDEROTH, LIND & PONACK, L.L.P., 2033 K STREET N. W., SUITE 800, WASHINGTON, DC, 20006-1021, US

(21) Appl. No.: 11/822,370

(22) Filed: Jul. 5, 2007

(30) Foreign Application Priority Data
Jul. 5, 2006 (EP) EP 06 013 897.1

(51) Int. Cl. B32B 15/085; B32B 11/06; B32B 15/09; B32B 37/00

(52) U.S. Cl. 442/378; 156/277; 156/278; 156/281; 156/60; 428/457; 428/458; 442/327; 442/395; 442/398; 442/414

(57) ABSTRACT

Multilayered composite material comprised of at least one flexible backing film and a nonwoven fabric or paper, characterized in that the composite material comprises at least two metallized layers disposed between the flexible backing film and the nonwoven fabric or paper and spaced apart from one another by one or several intermediate layers.

The invention relates to flame-retardant sun protection, glare protection and blackout articles, in particular for motor vehicles such as motor homes, trucks, boats, skylight windows, solaria and conservatories, private and public buildings, tents, tarpaulins and awnings and the like.

Sun protection articles for motor vehicles, skylight windows, solaria and conservatories and the like are known and are employed in order to prevent temperature increases caused by incident solar radiation in the interior of the motor vehicle or the room, as well as also blackout articles or glare protection.

Incident solar radiation can also heat the surfaces in the motor vehicle and therewith make touching the surfaces unpleasant for the user.

Direct incident solar radiation can further bleach textiles, for example seat covers and make them unsightly.

Through the use of sun protection, glare protection and blackout articles the insulation against heat as well as also against cold is achieved, IR radiation is kept from penetrating.

In a known embodiment these sun protection articles are available in the form of a curtain, preferably in pleated form.

In addition to the other required properties, such as for example UV resistance, moisture resistance and reflecting power, these pleated curtains must have acceptable reset behavior.

The invention addresses the problem of providing a composite suitable for sun protection or blackout articles, which has excellent pleatability, excellent reset behavior, high UV resistance and moisture resistance, as well as optimal sun protection properties and is, moreover, flame resistant.

The articles according to the invention should further also be utilizable as glare protection and therewith prevent glare through the sun, however, should optionally be transparent from the inside such that the view toward the outside is possible.

Subject matter of the invention is therefore a multilayered composite material comprised of at least one flexible backing film and a nonwoven fabric or paper, characterized in that the composite material comprises at least two metallized layers disposed between the flexible backing film and the nonwoven fabric and spaced apart by one or several intermediate layers.

As flexible backing film are preferably to be considered flexible transparent synthetic films, for example of PI, PP, MOPP, PE, PPS, PEEK, PEK, PEI, PU, PAEK, LCP, PEN, PBT, PET, PA, PC, COC, POM, ABS, PVC, PTFE, fluorocarbon polymers, such as Teflon and the like. The synthetic films preferably have a thickness of 5-700 μm, preferably 5-200 μm, especially preferred is a thickness of 5-50 μm.

As backing films can also further be utilized paper or composites with paper, for example composites with synthetic materials having a mass per unit area of 20-500 g/m², preferably 40-200 g/m². Synthetic paper, for example Polyart® or Tesslin® can further be utilized.

Especially preferred for use are films of polyolefins or polyester.

By nonwoven fabrics are here understood textiles, such as woven or nonwoven fabrics, such as continuous fiber nonwovens, staple fiber nonwovens, and the like, which may optionally be needled or calendered. Such woven or nonwoven fabrics are preferably comprised of synthetic materials, such as PP, PET, PA, PPS and the like, but woven or nonwoven fabrics of natural, optionally treated, fibers, such as viscose fiber, kenaf, hemp, sisal and the like can also be utilized. Mixed fiber nonwoven fabrics, bicomponent fiber nonwoven or filled nonwoven fabrics, for example carbon-filled nonwovens, can also further be utilized. The utilized nonwoven or woven fabrics have a mass per unit area of approximately 20 g/m² to 500 g/m². The nonwoven or woven fabrics can optionally be surface- and/or volume-treated.

Instead of the nonwoven fabric, paper or composites with paper, for example composites with synthetic materials having a mass per unit area of 20-500 g/m², preferably 40-200 g/m² can also be utilized. Further can be utilized synthetic paper, for example Polyart® or Tesslin®. The papers can optionally be surface- or volume-treated.

In a preferred embodiment the two materials (backing film or nonwoven fabric or paper) forming the outer surfaces of the composite material are treated such that they are flameproof.

By flameproof treatment is here understood a corresponding substrate treated with a flame retardant agent, or into which a flame retardant agent has optionally already been introduced during the production of the substrate.

For use as flame retardant agents are here considered in particular mono- or polyhalogenated hydrocarbons, such as mono- or polybromated or chlorinated hydrocarbons, halogen/antimony or metal hydroxides or halogen-free substances such as organophosphorus, phosphates, red phosphorus, melamine and their derivatives.

In a further preferred embodiment the two materials forming the outer surfaces of the composite are treated with UV-stabilizing additives, and/or fungicides and/or bacteriostatically acting substances. Especially advantageously are therein utilized known compounds which are not toxic to animals or humans.

To be considered as metallized layers are, for example, layers of a metal, such as Al, Cu, Fe, Ag, Au, Cr, Ni, Zn, Ti and the like as well as alloys such as for example Cu/Al, Al/Mg, Cr/Al. Further, wavelength-selective layers, for example multilayered metallic layers, alternate layers of metals or of metals and metal compounds (for example metal oxides) can be applied.

The coatings can be applied onto the backing substrate using known methods, for example printing techniques, metallization, vapor deposition, sputtering, electroplating, roller application techniques and the like.

The metallized layers can be applied over the entire surface or, in particular when using as glare protection, also partially in the form of a grid or in the form of one grid superimposed on another.

The thickness of the metallized layer is preferably 10-150 nm.

As intermediate layers disposed between the metallized layers are provided, for example, synthetic material films or paper and/or lacquer layers and/or adhesive layers and/or protective lacquer layers.

As synthetic material films provided as intermediate layers may be considered flexible synthetic material films, such as for example PI, PP, MOPP, PE, PPS, PEEK, PEK, PEI, PU, paper, PAEK, LCP, PEN, PBT, PET, PA, PC, COC, POM, ABS, PVC, fluorocarbon polymers and the like.

The synthetic material films have preferably a thickness of 5-700 μm, preferably 5-200 μm, and especially preferred is a thickness of 5-50 μm.

The synthetic material films may be transparent, translucent, opaque, black, white or colored, the colored synthetic material films being preferably substantially opaque or impermeable to light.

Especially preferred is the use of films of polyolefins or polyesters.

As intermediate layers can also be utilized paper or composites with paper, for example composites with synthetic materials having a mass per unit area of 20-500 g/m², preferably 40-200 g/m².

Further can be utilized synthetic paper, for example Polyart® or Tesslin®.

The papers can optionally be surface- or volume-treated.

The lacquer layers can be partially light-permeable or preferably light-impermeable and the lacquer layers may be colored, black or white.

To be considered are preferably pigmented or black or white or colored lacquer layers based on PET, PU, NC, acrylates, polyether, PA, PE, PP, EVA, PVC and the like. Pigments to be considered are, for example, inorganic-based pigments, such as titanium dioxide, zinc sulfide, kaolin, ITO, ATO, FTO, aluminum, chromium and silicon oxides, or organic-based pigments, such as phthalocyanine blue, i-indolidine yellow, dioxazine violet and the like. However, colored and/or encapsulated pigments, IR pigments, photochromic pigments, iridescent pigments, for example Iriodine®, and the like can also be utilized.

The pigments are, for example, embedded in chemically, physically or reactively drying binding agent systems.

Coloring substances to be considered are, for example, 1,1- or 1,2-chromium-cobalt complexes.

The pigments or the coloring substances have preferably a lightfastness >5.

The lacquer layer can also be embossed or, for example, filled. Fillers to be considered are, for example, glass beads.

The thickness of the lacquer layer is preferably 0.2 to 10 μm, preferably 0.5 to 1 μm.

Adhesive layers to be considered are, in particular, laminating polymer-based adhesive agent layers, for example based on polyurethanes, polyesters, acrylocopolymers, ethylene acrylate copolymer, epoxides, PVC, PA, PE, PP, water glass or their combinations or copolymers and the like.

However, thermoplastic adhesive layers, reactive adhesive layers, thermally drying, or self-adhering adhesive layers can also be utilized. The adhesive layer can be pigmented and/or black, white or colored. Pigments to be considered are, for example, all known pigments, for example inorganic-based pigments such as titanium dioxide, zinc sulfide, kaolin, ITO, ATO, FTO, aluminum, chromium and silicon oxides, or organic-based pigments such as phthalocyanine blue, i-indolidine yellow, dioxazine violet and the like. However, colored and/or encapsulated pigments, IR pigments, photochromic pigments, iridescent pigments, for example Iriodine® and the like can also be utilized.

The pigments are, for example, embedded in chemically, physically or reactively drying binding agent systems.

Coloring substances to be considered are, for example, 1,1- or 1,2-chromium-cobalt complexes.

The pigments or the coloring substances have preferably a lightfastness >5.

In a special embodiment the adhesive layer has elastic properties, in order to balance shearing forces between the layers.

Setting the degree of elasticity can take place, for example, through all-over or partial application of the adhesive layer or through suitable selection of the layer thickness. The elasticity can further be set through the structure of the adhesive layer, especially advantageous are here hexagonal structures.

Protective lacquer layers to be considered are physically or reactively drying layers on polymer basis, for example on the basis of polyurethanes, polyesters, acrylocopolymers, ethylene acrylate copolymer, epoxides, nitrocellulose, PVC colophonium resins, alkydes and the like.

The protective layer can be pigmented and/or black, white or colored. Pigments to be considered are, for example, all known pigments, for example inorganic-based pigments such as titanium dioxide, zinc sulfide, kaolin, ITO, ATO, FTO, aluminum, chromium and silicon oxides, or organic-based pigments such as phthalocyanine blue, i-indolidine yellow, dioxazine violet and the like. However, colored and/or encapsulated pigments, IR pigments, photochromic pigments, iridescent pigments, for example Iriodine®, and the like can also be utilized.

The pigments are, for example, embedded in chemically, physically or reactively drying binding agent systems.

Coloring substances to be considered are, for example, 1,1- or 1,2-chromium-cobalt complexes.

The pigments or coloring substances have preferably a lightfastness >5.

The protective lacquer layer can further be embossed.

These layers can be applied onto the backing substrate using known methods, for example printing techniques, roller application techniques and the like.

The composite according to the invention can be structured as follows in a preferred embodiment:

PEN film treated to be flame resistant

Lacquer layer colored or metallic layer

Laminating adhesive agent colored

Metallic layer

PET film perforated

Metallic layer

Protective lacquer embossed

Laminating adhesive agent colored

Synthetic paper (Polyart® or Tesslin®)

or

PEN film treated to be flame resistant

Lacquer layer colored or metallic layer

Laminating adhesive agent white

Metallic layer

PET film

Metallic layer

Laminating adhesive agent colored

Metallic layer

PET film white

Laminating adhesive agent

Nonwoven fabric treated to be flame resistant

The composites according to the invention can be produced using method steps described in the following:

Preparing a backing film

Metallizing and/or laminating, imprinting, embossing of the backing film

Preparing a further substrate

Laminating the two substrates onto one another

Lacquering, imprinting, embossing or metallizing the composite

Laminating onto a further substrate (nonwoven fabric or paper)

Optionally subsequent pleating of the composite.

The composites according to the invention have good pleatability, faultless reset behavior even after at least 10,000 movements, wherein through suitable selection of the layer thickness of the individual layers of the composites [influence] can be exerted onto the desired reset behavior.

The composites have further a high packing density (small radii of curvature during the pleating, thereby minimal space requirement), excellent hydrolysis resistance at 90% humidity, high UV resistance on the visible film side which is exposed to the incident solar radiation, for example, through a pane of glass, excellent black-out effect even at the edges after pleating and fulfill the criteria of flame resistance according to applicable standards.

### EXAMPLES

### Example 1

PEN film treated to be flame resistant 19 μm

Lacquer layer colored or metallic layer (Al) 0.5 μm/32 nm

Laminating adhesive agent white 3 g/m² polyether

Metallic layer 49 nm

PET film black 15 μm

Metallic layer 40 nm

Protective lacquer white 3 g/m² polyester

Laminating adhesive agent 8 g/m² polyurethane

Nonwoven fabric treated to be flame resistant 60-70 g/m² PET

The following tests were carried out on the composite:

Flame resistance:

The tested film composite meets the requirements according to §571.302 of the US Federal Regulation No. 302 with respect to refractoriness of materials used for the interior furnishings of motor vehicles.

UV resistance for application behind glass:

no change after 1000 hours of Xenotest

Test conditions: filter Xenochrome 320 nm Suprax cylinder according to ISO 12040

Hydrolytic resistance:

Test parameters: 60° C., 95% humidity, 2 weeks

no corrosion of the aluminum layers

Thermal insulation effect:

Direct radiation transmittance J 0.00%

Radiation reflectance D 0.67%

### Example 2

PEN film treated to be flame resistant 23 μm

Lacquer layer colored or metallic layer (Al) 2 g/m² PET/PVC

Laminating adhesive agent white 4 g/m² polyether

Metallic layer 20 nm

PET film 23 μm

Metallic layer 20 nm

Laminating adhesive agent black 4 g/m² polyether

Metallic layer 25 nm

PET film white 23 μm

Laminating adhesive agent 4 μg/m² (polyurethane)

Nonwoven fabric treated to be flame resistant 60-70 g/m²

The following tests were carried out on the composite:

Flame resistance:

The tested film composite meets the requirements according to §571.302 of the US Federal Regulation No. 302 with respect to refractoriness of materials used for the interior furnishings of motor vehicles.

UV resistance for application behind glass:

no change after 1000 hours of Xenotest

Test conditions: filter Xenochrome 320 nm Suprax cylinder according to ISO 12040

Hydrolytic resistance:

Test parameters: 60° C., 95% humidity, 2 weeks

no corrosion of the aluminum layers

Thermal insulation effect:

Direct radiation transmittance J 0.00%

Radiation reflectance D 0.67%

1) Multilayered composite material comprised of at least one flexible backing film and a nonwoven fabric or paper, wherein the composite material comprises at least two metallized layers disposed between the flexible backing film and the nonwoven fabric or paper and spaced apart from one another by one or several intermediate layers.

2) Composite material as claimed in claim 1, wherein the metallized layers are single-layered or multilayered layers.

3) Composite material as claimed in claim 1, wherein the intermediate layers disposed between the metallized layers are provided, synthetic films and/or lacquer layers and/or adhesive layers and/or protective lacquer layers.

4) Composite material as claimed in claim 1, wherein the lacquer layers are embossed or filled

5) Composite material as claimed in claim 1, wherein the backing film is comprised of polyolefins, PEN or polyester.

6) Composite material as claimed in claim 1, wherein the synthetic material backing film is treated to be flameproof.

7) Composite material as claimed in claim 1, wherein the nonwoven fabric is comprised of PET.

8) Composite material as claimed in claim 1, wherein the nonwoven fabric is treated to be flameproof.

9) Composite material as claimed in claim 1, wherein the intermediate layers are comprised of a synthetic material film of polyolefins or polyester and/or of a pigmented or black or white or colored lacquer layer and/or of a pigmented or black, white or colored polymer-based adhesive layer and/or of a black, white or colored or pigmented protective polymer-based lacquer layer.

10) Composite material as claimed in claim 1, wherein the metallic layer is comprised of Al, Cu, Fe, Ag, Au, Cr, Ni, Zn, Ti or alloys such as Cu/Al, Al/Mg, Cr/Al and/or metal oxides.

11) Method for the production of a composite material as claimed in claim 1, comprising the following steps:
preparing a backing film,
metallizing and/or laminating, imprinting, embossing the backing film,
preparing a further substrate,
laminating the two substrates onto one another,
lacquering, imprinting, embossing or metallizing of the composite,
laminating onto a further substrate (nonwoven fabric or paper), and
optionally subsequent pleating of the composite.

12) Sun, glare protection or blackout articles for motor vehicles, mobile homes, solaria and conservatories or skylight windows or applications in private and public buildings, comprising the composite material as claimed in claim 1.

13) Pleated sun protection articles for motor vehicles, mobile homes, solaria and conservatories or skylight windows or applications in private and public buildings, comprising the composite material of claim 1.
